(19) United States
(12) Patent Application Publication
(10) Pub. No.: US 2009/0201146 A1
(43) Pub. Date: Aug. 13, 2009

(54) REMOTE ACTIVITY DETECTION OR INTRUSION MONITORING SYSTEM

(76) Inventor: Wayne Lundeberg, Tucson, AZ (US)

Correspondence Address: HAYES SOLOWAY P.C., 3450 E. SUNRISE DRIVE, SUITE 140, TUCSON, AZ, 85718, US

(21) Appl. No.: 12/208,276

(22) Filed: Sep. 10, 2008

Related U.S. Application Data
(60) Provisional application No. 60/971,204, filed on Sep. 10, 2007.
(60) Provisional application No. 60/971,206, filed on Sep. 10, 2007.

(51) Int. Cl. G08B 1/08; G08B 21/00; G08B 13/00

(52) U.S. Cl. 340/539.3; 340/686.1; 340/550

(57) ABSTRACT

The system contains a motion sensor. In one embodiment a clock is in communication with the motion sensor. A processor is in communication with the motion sensor and the clock. The processor records a volume of motion sensed by the motion sensor as a function of time received in communications from the clock. An output device has a plurality of output signals. A plurality of threshold values stored in a memory is correlated with the output signals. A comparator is in communication with the output device, the memory, and the processor. The comparator compares the processor recordings to the threshold values stored in memory and initiates one of the plurality of output signals when the processor recordings exceed at least one of the threshold values. In another embodiment there is provided a system for detecting disturbance of a fence, comprising a plurality of motion sensor modules, each motion sensor module comprising a processor in communication with the motion sensors for distinguishing between a benign motion event and a fence disturbance event, and a wireless transmitter in communication with the micro-processor for transmitting signals when a possible fence disturbance event is detected; and a receiver at a command center for processing signals from the wireless transmitter and for signaling a possible fence disturbance event.

### CROSS REFERENCE TO RELATED APPLICATIONS

This application claims priority from the Provisional Application Ser. No. 60/971,204 and 60/971,206, both filed Sep. 10, 2007, the contents of which are incorporated herein by reference.

### FIELD OF THE INVENTION

The present invention is generally related to improvements in monitoring systems, and more particularly to systems for detecting and analyzing motion or intrusion. The invention in one aspect is useful for detecting motion and identifying the cause of the detected motion. The invention in another aspect has utility in connection with detection of disturbance of fences such as chain-link and will be described in connection with such utility, although other utilities are contemplated.

### BACKGROUND OF THE INVENTION

Motion detectors are well known in the prior art. Most prior art motion detectors detect motion within a sensed area, and, generally, provide a signal or other response indicative of sensed motion. Many motion detectors also have a controlled level of sensitivity, such that small objects or slight motion will not cause the signal to be initiated. Thus, most prior art motion detectors have a binary state (sensed motion/no sensed motion) bifurcated by a single threshold level. However, a signal essentially indicating that a greater than slight motion has occurred is not particularly informative.

Relatively large areas such as multiple building campuses, airports and the like, and national borders, are conventionally secured against undesired entry by way of chain-link fencing around the perimeter of the secured area or, in the case of border protection, along the border. Particularly for portions of the area which are not subject to constant human surveillance, either directly or by watch persons or indirectly by camera, remote detection of intrusion, fence disturbance or other breach of the perimeter fence allows deployment of the necessary security personnel as needed. In this way, effective asset protection and detection of fence disturbances including forced entry, breaching or events leading up to forced entry or fence breaching, can be effectively maintained with relatively few security personnel.

Various prior art systems for detecting fence disturbance are known. Such prior art systems typically rely on electronic strain gages, electronic continuity and contact switches for detecting a disturbance event. Such prior art systems have disadvantages in that they require considerable wiring and may be prone to high rates of false alarm due, for example, to triggering by weather conditions and/or contact by animals, blowing twigs and branches, etc.

### SUMMARY OF THE INVENTION

In broad aspect the present invention provide a system and method for detecting and categorizing movement. Briefly described, in architecture, one embodiment of the system, among others, can be implemented as follows. The system contains a motion sensor, a clock in communication with the motion sensor, and a processor in communication with the motion sensor and the clock. The processor records a volume of motion sensed by the motion sensor as a function of time received in communications from the clock. An output device has a plurality of output signals. A plurality of threshold values stored in a memory is correlated with the output signals. A comparator is in communication with the output device, the memory, and the processor. The comparator compares the processor recordings to the threshold values stored in memory and initiates one of the plurality of output signals when the processor recordings exceed at least one of the threshold values.

The present invention can also be viewed as providing methods for detecting and categorizing movement. In this regard, one embodiment of such a method, among others, can be broadly summarized by the following steps: recording a volume of motion sensed by a motion sensor with a processor as a function of time received in communications from a clock; comparing the processor recordings to a plurality of threshold values stored in a memory; and, initiating one of a plurality of output signals when the processor recordings exceed at least one of the threshold values.

The present invention in another aspect provides a fence disturbance system that employs a plurality of fence disturbance sensors, which include accelerometers, fixed in space relationship on a fence. The accelerometers transmit signals from the accelerometers to a processor which tests signals from the accelerometer against models, and classifies the disturbance as either benign, e.g. weather or animal related, or active such as fence climbing, fence rattling, or fence cutting. When an active activity is sensed, the detector transmits a signal to a central station command center alerting as to an active activity which may then be investigated by live personnel or by skewing cameras towards the location of the disturbance.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of a system for detecting and categorizing movement, in accordance with a first exemplary embodiment of the present invention;

FIG. 2 is a flowchart for a method for detecting and categorizing movement utilizing the system shown in FIG. 1, in accordance with the first exemplary embodiment of the present invention;

FIG. 3 is a schematic of a fence disturbance detection system in accordance with a second embodiment of the present invention;

FIG. 4 is a schematic flow diagram illustrating the procedure used for detecting, classifying, localizing and reporting fence intrusion disturbances according to the second embodiment of the present invention; and

FIG. 5 is a time-amplitude waveform of a fence disturbance detected by an accelerator according to the second embodiment of the present invention.

### DETAILED DESCRIPTION

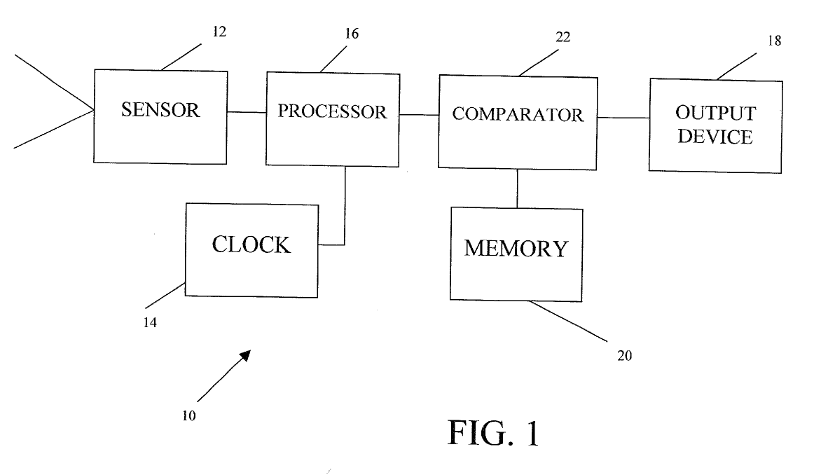

FIG. 1 is a block diagram of a system 10 for detecting and categorizing movement, in accordance with a first exemplary embodiment of the present invention. The system 10 includes a motion sensor 12 and a clock 14. A processor 16 is in communication with the motion sensor 12 and the clock 14. When the motion sensor 12 detects motion, the processor 16 records a volume of motion sensed by the motion sensor 12 as a function of time received in communications from the clock 14. As used herein the term “volume of motion” shall mean a measurable such as size or other measurable such as heat signature or object density related to the motion or sensed activity. An output device 18 has a plurality of output signals. A plurality of threshold values are stored in a memory 20 and correlated with the output signals. A comparator 22 is in communication with the output device 18, the memory 20, and the processor 16. The comparator 22 compares the processor 16 recordings to the threshold values stored in memory 20 and initiates one of the plurality of output signals when the processor 16 recordings exceed at least one of the threshold values.

The motion detector 12 may be any of a number of commercially available detectors 12 capable of detecting a measurable such as object size, heat signature or object density. Similarly, the clock 14 may be any of a number of commercially available products for keeping time within electronic devices. The output device 18 may be a light or other visual signaling device, an audible device, a transceiver used to transmit a signal to a wireless device or computer network, or any other known device for transmitting signals. The plurality of output signals may be differentiated from each other by frequency of repetition, color, volume, tone, use of words, or other differentiating means. The memory 20 may be any of a number of commercially available products for storing data within electronic devices.

The processor 16 may make use of one or more algorithms to record the volume of motion (or other measurable related to the motion) sensed by the motion sensor 12 as a function of time received in communications from the clock 14 and compare the volume of motion to a threshold. The volume of motion may indicate an object of approximately A×B dimensions moved across the sensed area. An individual aware of the triggering event may enter into the system 10 that the event was triggered by an animal that moved across the sensed area. Thereafter, a threshold value may be entered into the memory 20 signifying an object of A×B dimensions moving across the sensed area and, in the future, sensing that threshold value may result in initiating an output signal that indicates an animal (as opposed to a human or automobile) moved across the sensed area.

The plurality of threshold values may be dissimilar. For instance, one threshold value may be related to the approximately A×B dimensioned object moving across the sensed area. Another threshold value may be related to an object of any dimension greater than a minimal value moving across the entirety of the sensed area at a high rate of speed. Another threshold value may be related to any movement by an object of C×D dimensions or greater. If a motion sensor has an infrared signal, a threshold value could be tied to a heat signature or a minimal heat output. However, there are many possible permutations of the thresholds for the present invention, at least as varied as the known permutations of motion sensor technology available. Similarly, the comparator 22 may be designed to compare each threshold value to the corresponding data recorded by the processor 16.

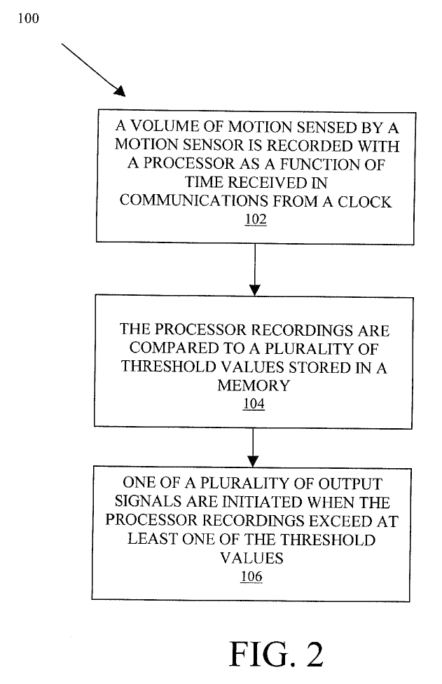

FIG. 2 is a flowchart 100 for a method for detecting and categorizing movement utilizing the system 10 shown in FIG. 1, in accordance with the first exemplary embodiment of the present invention. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

As is shown by block 102, a volume of motion sensed by a motion sensor is recorded with a processor as a function of time received in communications from a clock. The processor recordings are compared to a plurality of threshold values stored in a memory (block 104). One of a plurality of output signals are initiated when the processor recordings exceed at least one of the threshold values (block 106) or occurred outside of a predetermined time. For example, the motion detector would be able to distinguish human presence from a dog presence, and those activities to a priority of high or low, depending on the time and place, and provide an approximate signal, e.g., “Dog roaming in home during work hours”, or “Intruder in lab after work hours”.

In another embodiment of the present invention there are provided improvements over prior art fence disturbance systems by affixing self-contained self-powered accelerometers spaced along a fence. The fence may be a chain-link or welded wire fence or other form of wire fencing or the like, or bar, slat or plate fencing. Each accelerator module comprises a separate node that can individually report, wirelessly, fence disturbances and intrusions.

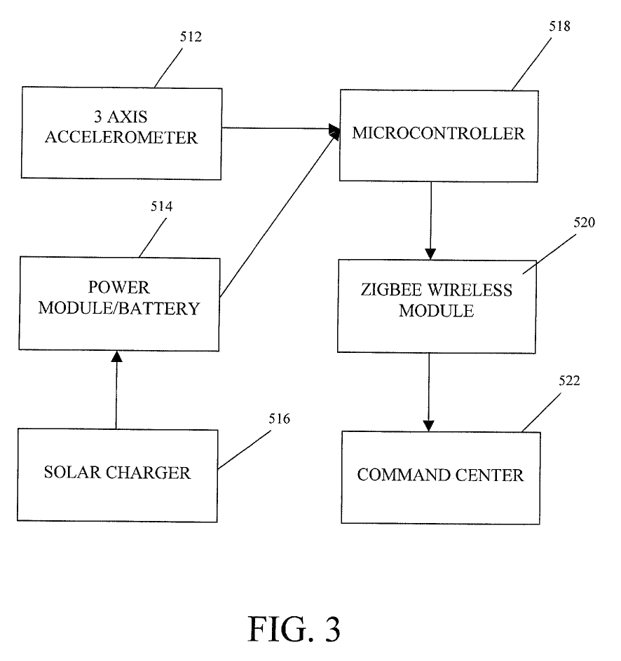

Referring to FIG. 3, each fence disturbance/intrusion sensor comprises a three-axis accelerator which has been tuned to discriminate between slight fence movements such as might occur by weather disturbances or an animal accidentally running into the fence (so-called benign events), and a human-caused event such as fence-climbing, fence-rattling or attempts to cut through the fence (so-called active events). In architecture the sensor includes a three-axis accelerometer 512, a power supply 514 including a battery and optionally including a solar cell 516, and a micro-computer 518 which discriminates signals from the accelerometer and classifies the disturbances as either active or inert. When an active disturbance is sensed, the micro-computer sends a signal to a digital radio such as an ZigBee wireless digital radio transmitter 520 that transmits a disturbance detection signal to a repeater station (not shown) or directly to a command center 522 where action may be initiated to investigate the disturbance.

Each ZigBee wireless module is programmed to include an identification code specific to its associated sensor. While ZigBee devices are preferred due to their relatively low power consumption, the incorporation of a micro-computer and software in the sensor module permits significant benefits in terms of real-time applications including saving of transmission power and shipment primarily only of result activity detection data to the command center rather than the shipment of an entire stream of raw accelerometer data which then must be analyzed.

While ZigBee transmitters are rugged, low-cost and have relatively low power consumption and thus are preferred. It will be noted however that other wireless transmission protocols advantageously may be employed in the present invention. Particularly preferred for use in the present invention are XBee-Pro transmitter modules are available from MaxStream, Inc.

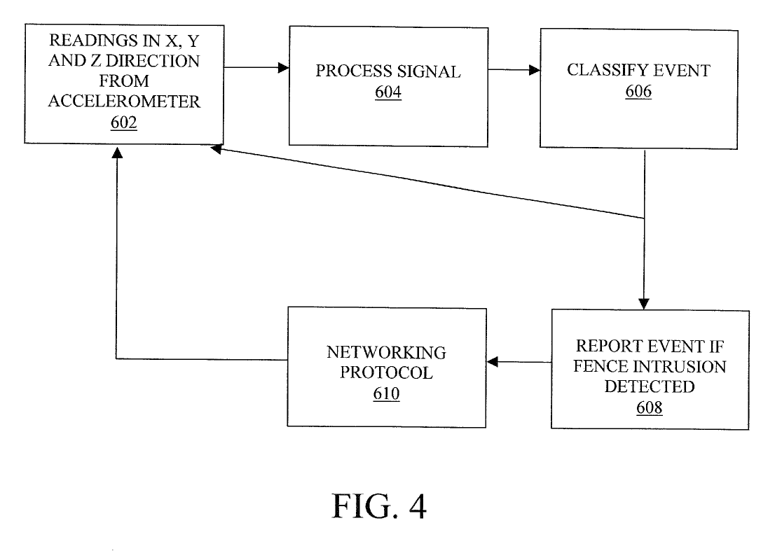

FIG. 4 is a flow chart 600 illustrating data and signal flow in accordance with a second exemplary embodiment of the present invention. As shown in block 602, an accelerator which is mounted to the fence measures acceleration in the X, Y and Z directions, as may result from events such as weather disturbances or an animal running into the fence (a benign event) or a human intrusion event such as climbing, kicking, cutting, rattling, etc. (an active event), and sends raw data signals to a signal processor 604 which processes the signals and classifies the signals (block 606) as benign or active, i.e. an intrusion event. When an intrusion event is sensed, a signal, optionally including raw data from the accelerometer, is transmitted to a command center (block 608) using, for example, a ZigBee wireless transmitter or the like.

The signals from the ZigBee wireless module are then classified and analyzed using dynamic synapse neural network (DSNN) processing such as described in U.S. Pat. No. 6,643,627 to Liaw et al. and U.S. Pat. No. 7,203,132 to Berger.

Completing the system is a networking protocol which manages the network of wireless sensors using ZigBee modules. Since each sensor system periodically transmits its own identification signal, networking protocol 610 permits monitoring and checking for failed devices and dead batteries, as well as tampering of devices. Thus, the system has the capability of forming a self-healing, self-informing network facilitating maintenance and monitoring of remote modules spaced along a fence

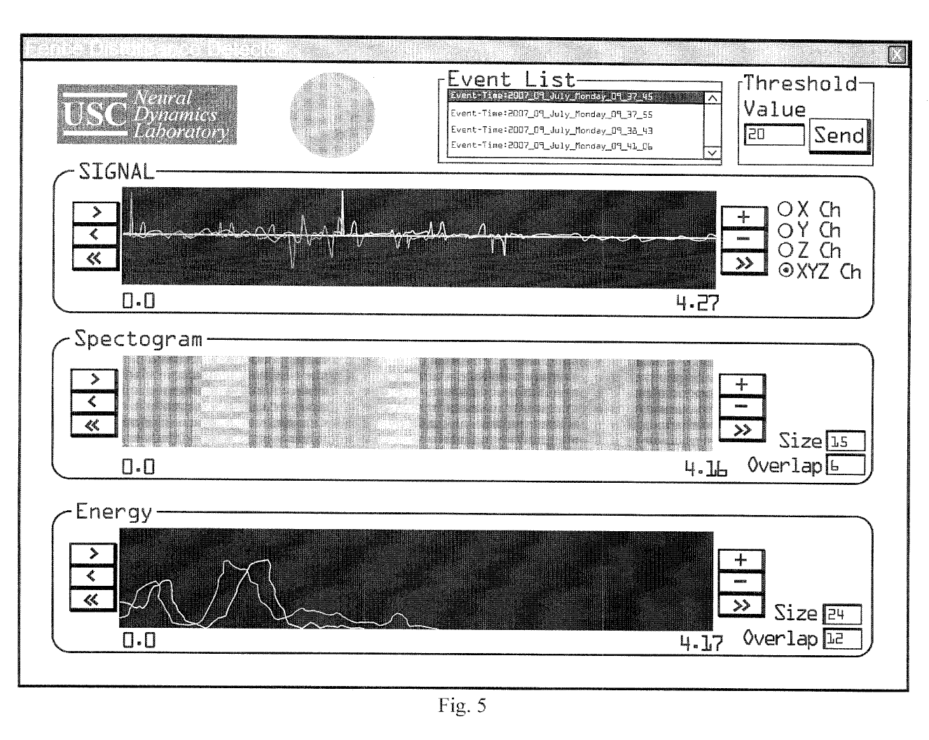

FIG. 5 shows a time-amplitude waveform of the rattling of a chain-link fence equipped with an intrusion sensor in accordance with the present invention.

It should be emphasized that the above-described embodiments of the present invention, particularly, any “preferred” embodiments, are merely possible examples of implementations, merely set forth for a clear understanding of the principles of the invention. For example, the output of a positive event may be integrated with and plotted against a location using, e.g., Google Earth (http://earth.google.com). Many variations and modifications may be made to the above-described embodiment of the invention without departing substantially from the spirit and principles of the invention. All such modifications and variations are intended to be included herein within the scope of this disclosure and the present invention and protected by the following claims.

What is claimed is:

1. A system for detecting and categorizing movement, comprising:
a motion sensor;
a clock;
a processor in communication with the motion sensor and the clock, wherein the processor records a volume of motion sensed by the motion sensor as a function of time received in communications from the clock;
an output device having a plurality of output signals;
a plurality of threshold values stored in a memory and correlated with the output signals; and
a comparator in communication with the output device, the memory, and the processor, wherein the comparator compares the processor recordings to the threshold values stored in memory and initiates one of the plurality of output signals when the processor recordings exceed at least one of the threshold values.

2. The system of claim 1, further comprising an input device in communication with the memory, whereby an event that initiates one of the plurality of output signals can be input into memory and designated with a specific threshold value.

3. The system of claim 1, wherein the volume of motion is selected from the group consisting of object size, heat signature and object density.

4. A method for detecting and categorizing movement, comprising the steps of:
recording a volume of motion sensed by a motion sensor with a processor as a function of time received in communications from a clock;
comparing the processor recordings to a plurality of threshold values stored in a memory; and
initiating one of a plurality of output signals when the processor recordings exceed at least one of the threshold values.

5. The method of claim 4, further comprising storing information of at least one incident that results in initiating one of the plurality of output signals, wherein the stored information comprises processor recordings of the incident.

6. The method of claim 5, further comprising inputting into the memory a cause of the incident and defining one of the threshold values according to the processor recordings of the incident.

7. The method of claim 4, wherein the volume of motion is selected from the group consisting of object size, heat signature and object density.

8. A article of manufacture comprising a computer readable medium having computer readable program code disposed therein for categorizing movement, the computer readable program code comprising a series of computer readable program steps to effect:
recording a volume of motion sensed by a motion sensor with a processor as a function of time received in communications from a clock;
comparing the processor recordings to a plurality of threshold values stored in a memory; and
initiating one of a plurality of output signals when the processor recordings exceed at least one of the threshold values.

9. The article of manufacture of claim 8, said computer readable program code further comprising a series of computer readable program steps to effect:
storing information of at least one incident that results in initiating one of the plurality of output signals, wherein the stored information comprises processor recordings of the incident.

10. The article of manufacture of claim 9, said computer readable program code further comprising a series of computer readable program steps to effect:
inputting into the memory a cause of the incident and defining one of the threshold values according to the processor recordings of the incident.

11. A system for detecting disturbance of a fence, comprising
a plurality of motion sensor modules, each motion sensor module comprising a processor in communication with the motion sensors for distinguishing between a benign motion event and a fence disturbance event, and a wireless transmitter in communication with the micro-processor for transmitting signals when a possible fence disturbance event is detected; and
a receiver at a command center for processing signals from the wireless transmitter and for signaling a possible fence disturbance event.

12. The system of claim 11, wherein the wireless transmitter operates on a ZigBee protocol.

13. The system of claim 11, wherein the motor sensor modules each comprise a three axis (X, Y, Z) accelerometer.

14. The system of claim 11, wherein signals from the motion sensor modules are analyzed using a DSNN.

15. The system of claim 11, wherein each motion sensor module transmits a unique identifying signal.

16. The system of claim 15, wherein each motion sensor module sends a periodic status signal to the command center.

17. A method for detecting disturbances at a fence and for distinguishing between benign disturbances and intrusion disturbances, comprising the steps of
providing a fence with a plurality of motion sensor modules;
sensing motion using said motion sensor modules and processing signals from the motion sensor modules to classify the motion as benign or as a possible intrusion; and
transmitting signals to a command center when a possible intrusion event is detected.

18. The method of claim 17, wherein output signals from the motion sensor modules are processed using DSNN.

19. The method of claim 17, wherein a plurality of motion sensor modules are deployed along a fence, each having a unique identification signal.

20. The method of claim 17, wherein each motion sensor module sends a status signal, and including the step of initiating an investigation of a motion sensor module based on the status signal.

21. An article of manufacture comprising a computer-readable medium having computer readable program code disposed therein for categorizing movement, the computer-readable program code comprising a series of computer-readable program steps to effect:
distinguishing between a benign movement event and an intrusion movement event; and
reporting the intrusion movement event to a command center.

22. The method of claim 4, including the step of plotting the detected and categorized movement against a location.

23. The method of claim 17, including the step of plotting the detected disturbance against a location.
